(19) United States
(12) Patent Application Publication
(10) Pub. No.: US 2002/0059609 A1
(43) Pub. Date: May 16, 2002

(54) METHOD AND COMPUTER PROGRAM PRODUCT FOR REMOTE SURFING CONTROL

(76) Inventors: BRIAN JOHN CRAGUN, ROCHESTER, MN (US); PAUL REUBEN DAY, ROCHESTER, MN (US)

Correspondence Address: JOAN PENNINGTON, 535 NORTH MICHIGAN AVENUE, UNIT 1804, CHICAGO, IL, 60611

(21) Appl. No.: 09/166,429

(22) Filed: Oct. 5, 1998

(51) Int. Cl. G06F 3/00

(52) U.S. Cl. 725/56

(57) ABSTRACT

A method, computer program product and system are provided for remote surfing control for television viewing. User input selections are received for defining a profile. The profile includes at least one channel list. Responsive to identifying a user input surfing selection, a channel list is identified from the profile. The identified channel list is used for selecting a channel responsive to the user input surfing selection. A surfing mode and a timer event are set responsive to the user input surfing selection. Other events, each including an event date and time and selected channel, are set responsive to user input selections. When an event including a timer event is identified, an audible signal is issued for the viewer, and a predefined viewing channel is set. When an event is identified and the television is off, the television is powered on and checking for a user acknowledgment signal is performed. When the user acknowledgment signal is not received within a predefined time period, the television is powered off.

### FIELD OF THE INVENTION

The present invention relates generally to the data processing field, and more particularly, relates to a method, computer program product and system for providing remote surfing control for television viewing.

### DESCRIPTION OF THE RELATED ART

During a commercial message on a television or radio program, people like to surf from channel to channel. The intent is to come back to the first program being viewed or to the original radio program, but it is easy to forget and get preoccupied with some other thing. As a result, the user may miss part or all of the remaining program. Also there may be a show that a viewer wants to watch at a later time. It is easy to be distracted by other activities and forget.

Various arrangements have been proposed for television operational control and to allow a viewer to avoid commercial messages. For example, U. S. Pat. No. 4,918,531 discloses a commercial message timer, when enabled by a user stores data indicative of a first tuned station and begins timing a predetermined time period. Upon expiration of the time period, the first tuned station is automatically reselected if it had been deselected after the timer was enabled. U.S. Pat. No. 4,979,047 discloses a similar commercial message timer arrangement with a display element coupled to the timer circuit to indicate to the viewer when the predetermined time period has expired, so that the viewer may, if he chooses, return to the original channel or the “unpaused” mode in a VCR.

U.S. Pat. No. 4,821,122 discloses a receiver including a video switch operated by a controller for selecting antenna or auxiliary (baseband) video signals for display. When placed in a VCR operating mode the controller first selects the auxiliary input for display. If a video signal is not present at the auxiliary input the controller causes the switch to select the output of a tuner thereby providing an automatic signal search to locate the VCR signal which may be applied to either of the antenna and auxiliary inputs. An extension of the search includes tuning the tuner to channel 3 and, if no signal is found, tuning the tuner to channel 4. Upon failure to find an active video signal on either channel the tuner is returned to the last channel received prior to selecting the VCR mode of operation thereby relieving the user of both mode selection and channel selection requirements for locating the VCR signal.

U.S. Pat. No. 3,870,956 discloses a sound muting circuit used with a television or radio receiver by remote control, activated by a muting switch to disable the sound for a predetermined time after which the sound is automatically reconnected.

A need exists for a mechanism enabling efficient and effective remote surfing control for television viewing. For example, a way is needed to notify of events that are not just commercial end events. A way is needed to alert a user that is not in the room or is not viewing the television without being startling. A way is needed to make surfing selections match user interests more closely. A way is needed to make surfing selections match the time of day or the day of week. As used in the present description and claims, the term television should be understood to include a radio receiver.

### SUMMARY OF THE INVENTION

A principal object of the present invention is to provide an improved method, computer program product and system for providing remote surfing control for television viewing. Other important objects of the present invention are to provide such method, computer program product and system for providing remote surfing control for television viewing substantially without negative effects and that overcome some disadvantages of prior art arrangements.

In brief, a method, computer program product and system are provided for remote surfing control for television viewing. User input selections are received for defining a profile. The profile includes at least one channel list. Responsive to identifying a user input surfing selection, or responsive to a date and time of surfing, a channel list is identified from the profile. The identified channel list is used for selecting a channel responsive to the user input surfing selection.

In accordance with features of the invention, a surfing mode and a timer event are set responsive to the user input surfing selection. Other events, each including an event date and time and selected channel, are set responsive to user input selections. When an event including a timer event is identified, an audible signal is issued for the viewer, and a predefined viewing channel is set. When an event is identified and the television is off, the television is powered on and checking for a user acknowledgment signal is performed. When the user acknowledgment signal is not received within a predefined time period, the television is powered off.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating a television system for implementing surfing control methods for television viewing in accordance with the preferred embodiment;

FIGS. 2 and 3 together provide a flow chart illustrating exemplary sequential steps for providing surfing control for television viewing of the preferred embodiment;

FIG. 4 is a flow chart illustrating exemplary sequential steps for processing user entered menu selections of the preferred embodiment;

FIG. 5 is a flow chart illustrating exemplary sequential steps for incrementing and decrementing channel control of the preferred embodiment;

FIG. 6 is a diagram illustrating exemplary menu selections of the preferred embodiment;

FIG. 7A and 7B are diagrams illustrating exemplary user profiles of the preferred embodiment;

FIG. 8 is a flow chart illustrating exemplary sequential steps for modifying user profiles of the preferred embodiment;

FIG. 9 is a flow chart illustrating exemplary sequential steps for displaying and modifying a user profile of the preferred embodiment;

FIG. 10 is a diagram illustrating an exemplary event record of the preferred embodiment;

FIG. 11 is a diagram illustrating an exemplary profile record together with channel list records of the preferred embodiment;

FIGS. 12A and 12B illustrate exemplary remote control devices of the preferred embodiment; and

FIG. 13 is a block diagram illustrating a computer program product in accordance with the preferred embodiment.

### DETAILED DESCRIPTION OF THE PREFERRED EMBODIMENTS

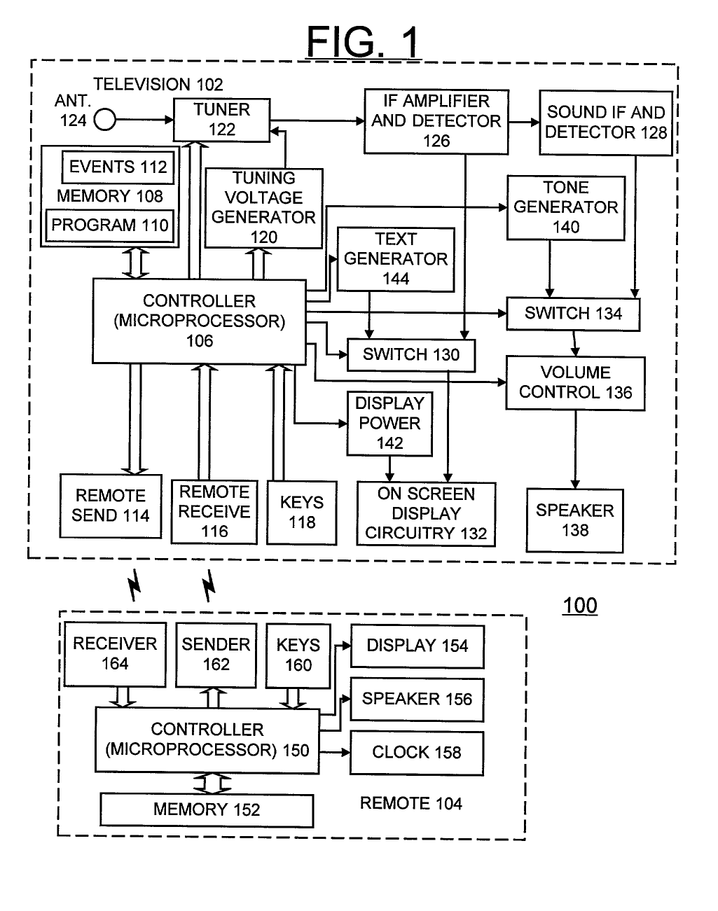

Referring now to the drawings, in FIG. 1 there is shown a block diagram representation illustrating a system of the preferred embodiment generally designated by the reference character 100. System 100 implements surfing control methods for television viewing in accordance with the preferred embodiment.

As shown in FIG. 1, system 100 includes a television receiver 102 and a remote control device 104. The television and the remote control 104 are operated by a user for entering selections in accordance with features of the preferred embodiment. The television receiver 102 includes a controller or microprocessor 106 and a memory 108 storing a control program 110 and events 112 of the preferred embodiment. Control program 110 stored in memory 108 operatively controls the microprocessor 106. Microprocessor 106 is connected to a remote send 114, a remote receive 116 and a plurality of input keys 118 for communicating with the remote 104 and receiving user selections. Microprocessor 106 is connected to a tuning voltage generator 120 and a tuner 122 for controlling a tuned channel. A television antenna 124 or equivalent for receiving a broadcast television signal is connected to the tuner 122. The television receiver 102 includes an IF amplifier and detector 126 and a sound IF and detector 128 coupled to the tuner 122. The IF amplifier and detector 126 is coupled via a switch or multiplexer 130 to on screen display circuitry 132. Sound IF and detector 128 is coupled via a switch or multiplexer 134 and a volume control 136 to a speaker 138. A tone generator 140 operatively controlled by the microprocessor 106 provides an input to the switch 134 coupled to speaker 138. A display power switch 142 operatively controlled by the microprocessor 106 controls power on and off to the on screen display circuitry 132. A text generator 144 operatively controlled by the microprocessor 106 provides an input to the switch 130 coupled to the on screen display circuitry 132.

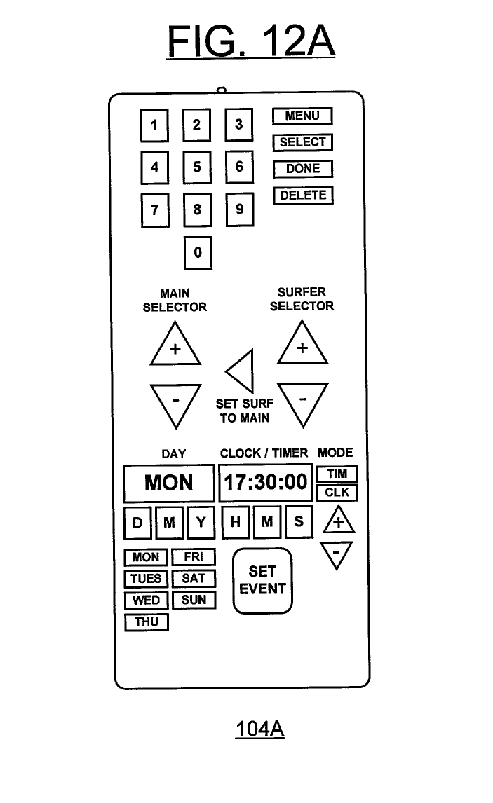

Remote control device 104 includes a controller or microprocessor 150 and a memory 152. Microprocessor 150 is connected to a display 154, a speaker 156, and a clock 158. Microprocessor 150 is connected to a plurality of input keys 160, a remote send 162, a remote receive 164 for receiving user selections and communicating with the television 102. Alternative remote control devices 104A and 104B are illustrated in FIGS. 12A and 12B. The remote control device 104B is the preferred embodiment.

As shown in FIGS. 12A and 12B, remote control keys 160 include main selector and surfer selector up/down keys and a key labeled SET SURF TO MAIN. A set of input keys labeled MENU, SELECT, DONE, and DELETE receive user input surfing control selections. A set of input keys are provided for selecting days of the week and time and to set an event. Under normal television use, the user changes channels with standard channel buttons. When the user wants to use surfing control of the preferred embodiment, the surfing function buttons are used. In FIG. 12A, the remote control 104A includes timer and clock mode control keys for setting a clock/timer. In FIG. 12B, the remote control 104B includes a separate timer and clock and the timer and clock mode control keys are not required.

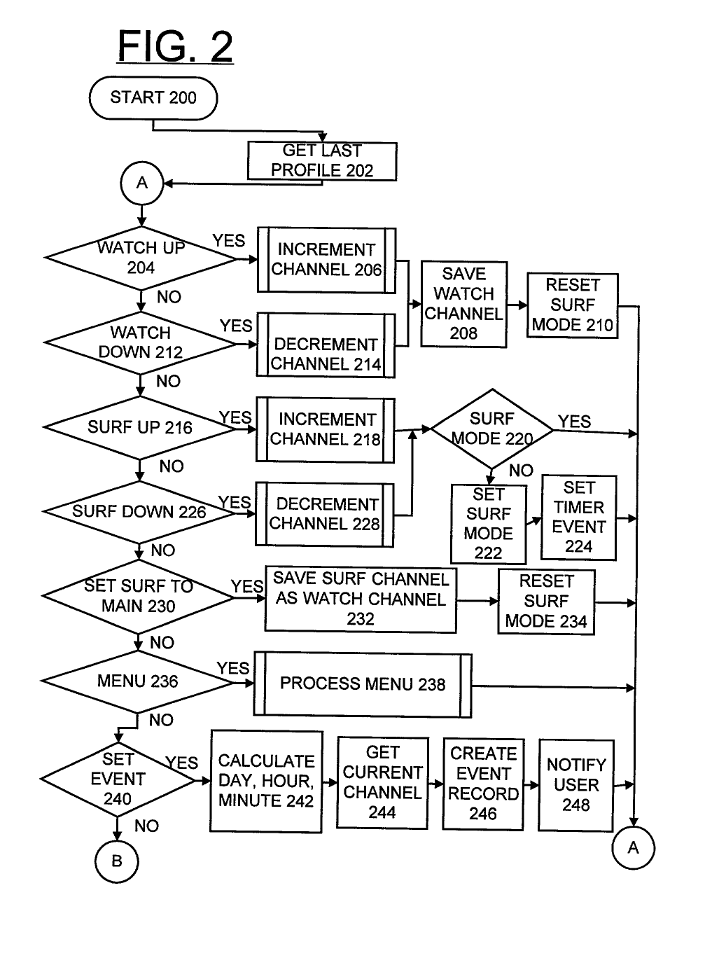

Referring now to FIGS. 2 and 3, exemplary sequential steps for providing surfing control for television viewing of the preferred embodiment are shown. Sequential operations starting at block 200 begin with retrieving a last profile as indicated at a block 202.

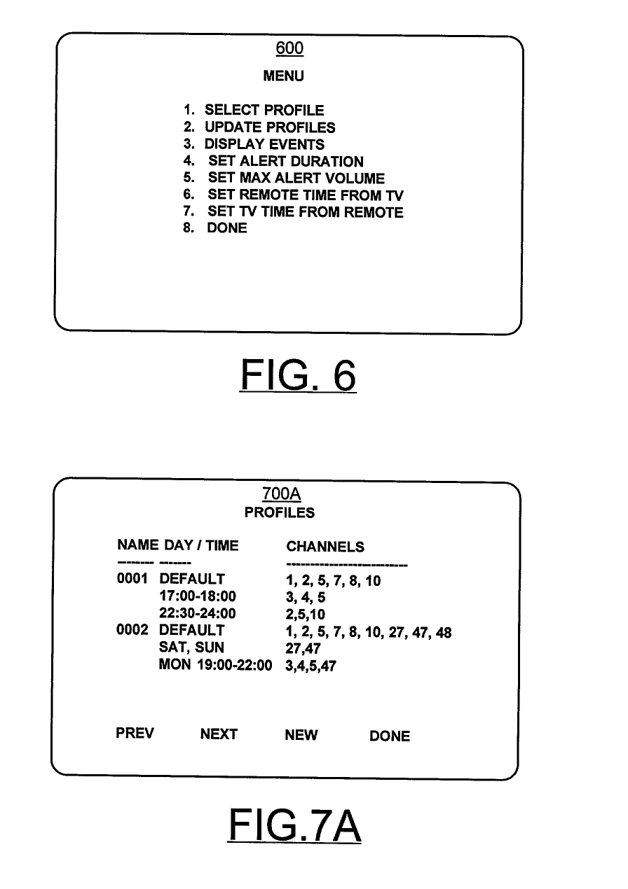

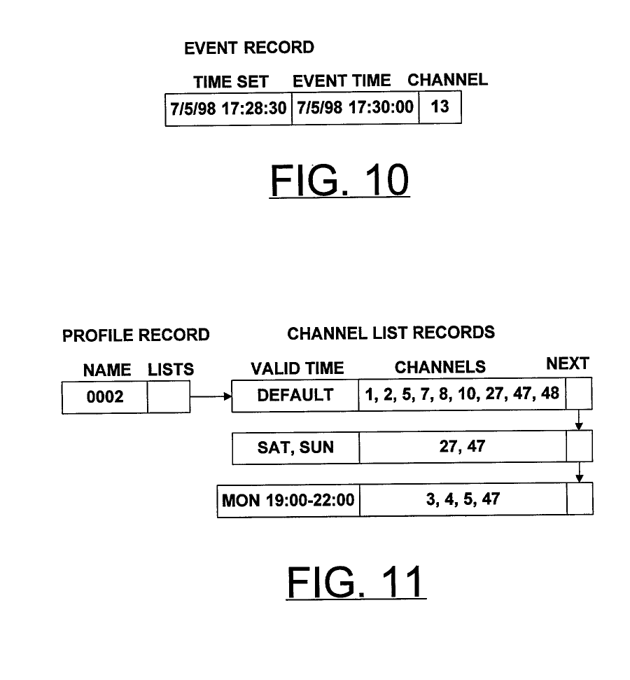

FIG. 7A and 7B illustrate exemplary user profiles 700A, 700B of the preferred embodiment. FIG. 11 illustrates an exemplary profile record together with channel list records of the preferred embodiment. As shown in FIG. 7A, 7B and 11, the profile record includes a name together with stored day and/or time and channel values. Each profile record has one or more channel list records. Each channel list record stores a set of channels that should be used for up/down channel selection during a certain time.

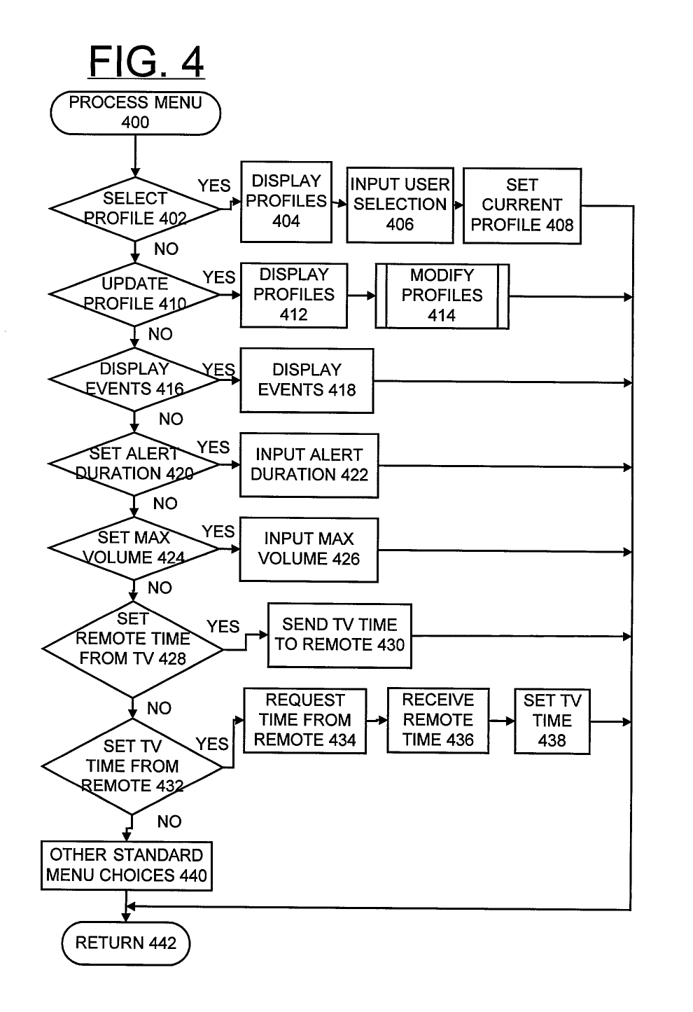

In FIG. 2, checking for a watch up user selection, which is implemented as the “+” key of the remote control main selector keys, is performed as indicated at a decision block 204. The watch up/down main selector buttons are used when the user wants to change channels and watch for longer periods and have their selections remembered. When watch up user selection is identified, an increment channel routine is performed as indicated at a block 206. The watch channel is saved as indicated at a block 208 and the surf mode is reset as indicated at a block 210, which resets the timer to its current full countdown value and sets the surf mode indicator to off. Checking for a watch down user selection is performed as indicated at a decision block 212, which is implemented as the “−” key of the main selector keys. When watch down user selection is identified, a decrement channel routine is performed as indicated at a block 214. Then the watch channel is saved at block 208 and the surf mode is reset or turned off at block 210. Then the sequential operations return to entry point A. The increment/decrement channel routine is illustrated and described with respect to FIG. 5.

When the watch down user selection is not found, checking for a surf up user selection is performed as indicated at a decision block 216, which is implemented as the 11+11 key of the surfer selector. If found, the increment channel routine is performed as indicated at a block 218. Then checking whether the surf mode is set is performed as indicated at a decision block 220. If not set, then the surf mode is set as indicated at a block 222 and a timer event is set as indicated at a block 224. When the surf mode and timer event are set, then the sequential operations return to entry point A.

Checking for a surf down user selection is performed as indicated at a decision block 226, which is implemented as the “−” key of the surfer selector. If found, the decrement channel routine is performed as indicated at a block 228. Then checking whether the surf mode is set is performed at decision block 220. If not set, then the surf mode is set at block 222 and the timer event is set at block 224. When the surf mode and timer event are set, then the sequential operations return to entry point A.

Otherwise when surf down is not found, checking for set surf to main user selection is performed as indicated at a decision block 230. This is pressed by the user to cause the channel being surfed to become the main selected channel and stop the surf countdown. If watch surf user selection is found then the surf channel is saved as the watch channel as indicated at a block 232. Then the surf mode is reset as indicated at a block 234. Then the sequential operations return to entry point A to continue monitoring for user selections.

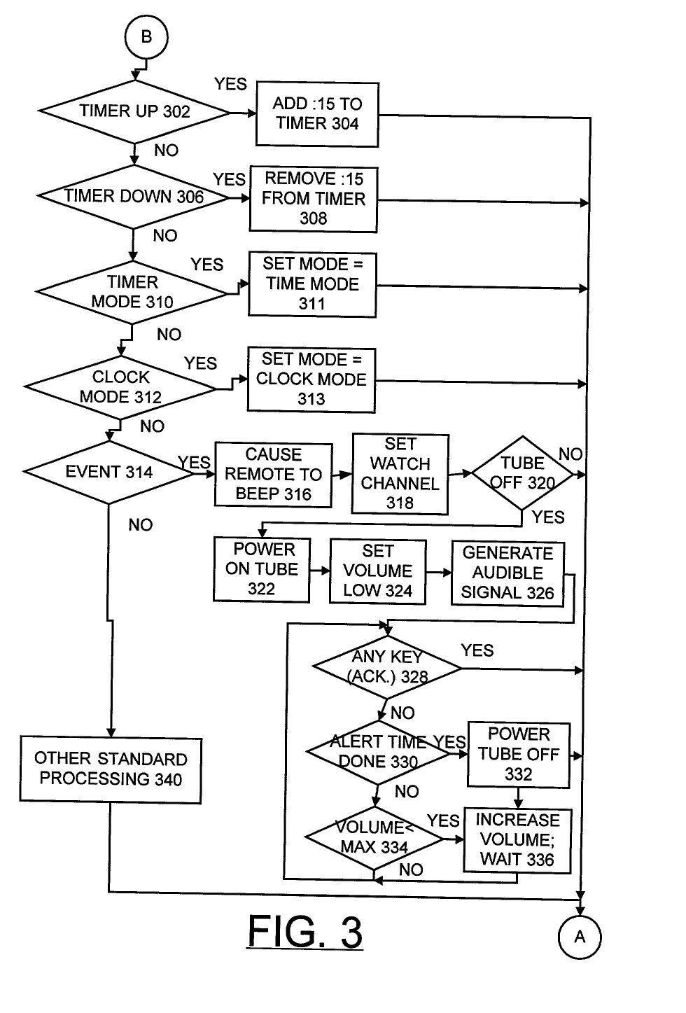

When the watch surf user selection is not found, then checking for a menu user selection is performed as indicated at a decision block 236. When the menu user selection is identified, then a process menu routine is performed as indicated at a block 238. The process menu routine is illustrated and described with respect to FIG. 4. Then the sequential operations return to entry point A to continue monitoring for user selections.

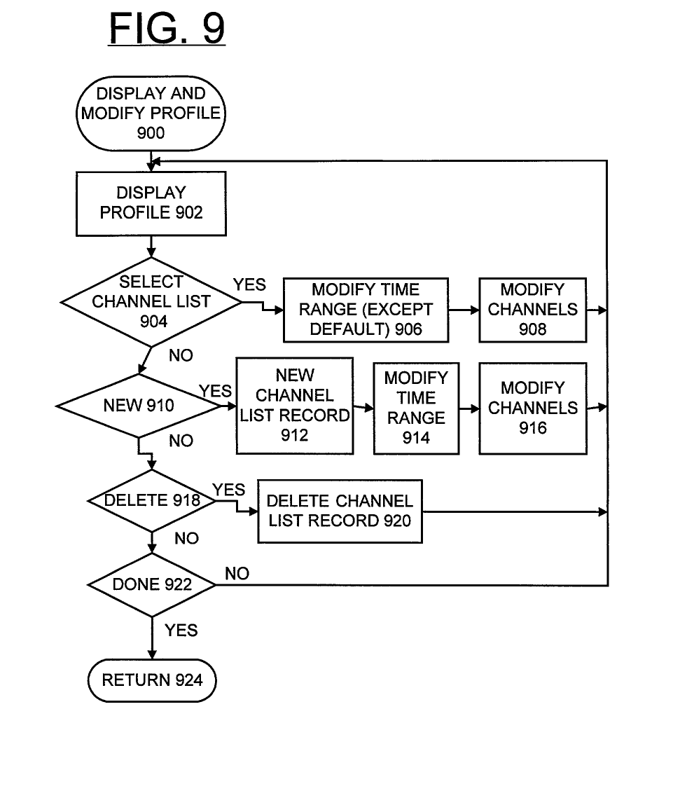

Otherwise when the menu user selection is not found, then checking for a set event user selection is performed as indicated at a decision block 240. If the set event user selection is found, then day, hour, and minute of the event are calculated as indicated at a block 242. A current channel is identified as indicated at a block 244 and an event record is created as indicated at a block 246 containing the event information from block 242 and channel from block 244. The user is notified as indicated at a block 248 by an audible tone or an onscreen indicator and the sequential operations return to entry point A. An exemplary event record of the preferred embodiment is illustrated in FIG. 10.

Referring also to FIG. 10, the event record includes a time set which is the time the event was created, event time which is the time the event will fire and channel. A list of events 112 is kept in memory 108. When the set event user selection is not found, then the sequential operations continue following entry point B in FIG. 3.

Referring to FIG. 3, checking for a timer up user selection is performed as indicated at a decision block 302, which is the “+” key of the timer. If the timer up user selection is found, then a predefined increment of time is added to the remote timer as indicated at a block 304. Then the sequential operations return to entry point A in FIG. 2 to continue monitoring for user selections. Otherwise checking for a timer down user selection is performed as indicated at a decision block 306, which is implemented as the “−” key of the timer of remote control device 104. If the timer down user selection is found, then a predefined increment of time is subtracted from the remote timer as indicated at a block 308. Then the sequential operations return to entry point A in FIG. 2 to continue monitoring for user selections. Checking for a timer mode user selection is performed as indicated at a decision block 310. If found, then the time entry mode is set to timer as indicated at a block 311. Otherwise if the timer mode is not found, then checking for a clock mode user selection is performed at block 312. If found, the time entry mode is set to the clock mode in block 313. Then checking for an event is performed as indicated at a decision block 314.

When the actual time reaches the time in an event record, an event is identified at block 314, then the remote 104 is caused to beep issuing an audible signal to the user as indicated at a block 316. The watch channel for the event is set as indicated at a block 318. Checking whether the tube is off is performed as indicated at a decision block 320. If the tube is on, then the sequential operations return to entry point A. If off, the tube is powered on as indicated at a block 322 and the volume is set low as indicated at a block 324. Then an audible signal is generated by the television 102 as indicated at a block 326. Checking for acknowledge user entry is performed as indicated at a decision block 328. If an acknowledge user entry is received, then the sequential operations return to entry point A. Otherwise if an acknowledge user entry is received, then after a predefined alert time as indicated at a decision block 330, the tube is powered off as indicated at a block 332. Before the predefined alert time period expires, the volume setting is compared with a defined maximum setting as indicated at a decision block 334. When the volume setting is less than the defined maximum setting, the volume is increased as indicated at a block 336. The operations return to decision block 328 and continue until the predefined alert time period expires. Then the sequential operations return to entry point A. Otherwise, when an event is not identified at block 314, then other standard processing is performed as indicated at a block 340.

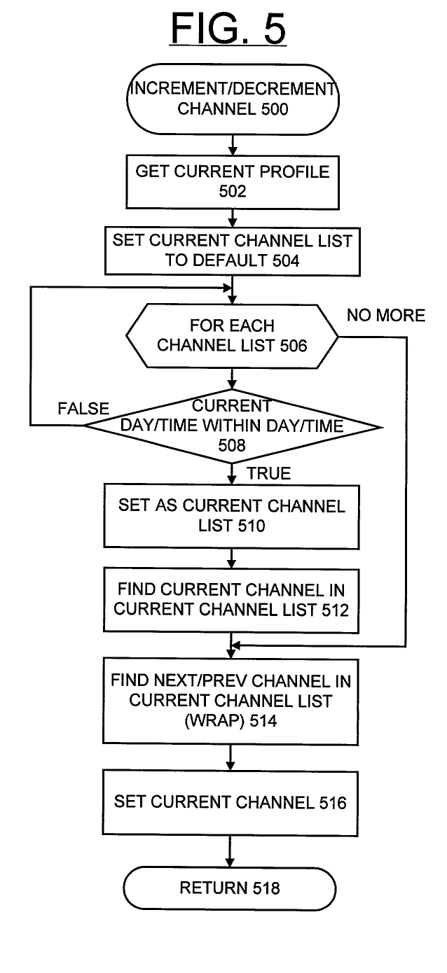

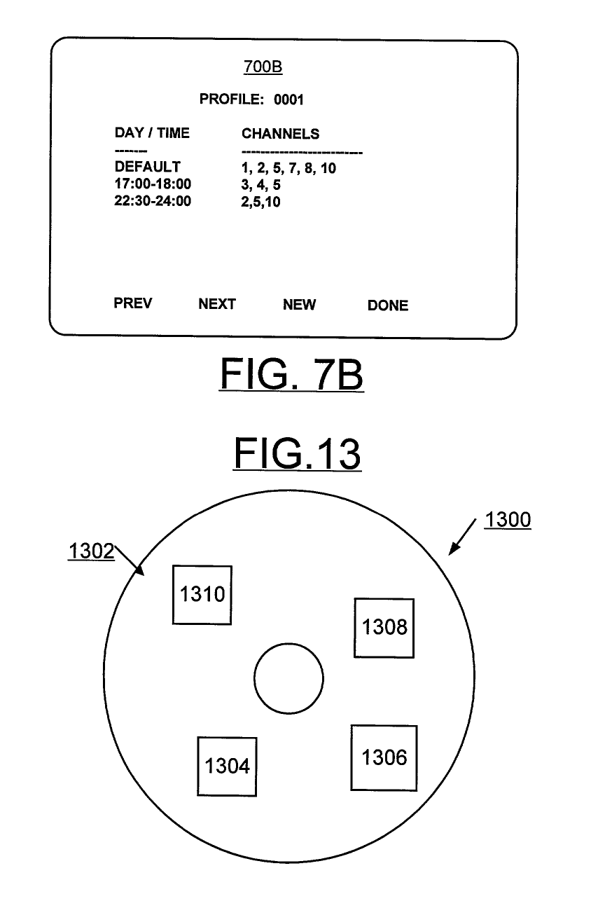

Referring now to FIGS. 4 and 6, menu user selections of the preferred embodiment are shown. FIG. 4 illustrates exemplary sequential steps for processing user entered menu selections of the preferred embodiment starting at block 400. FIG. 6 illustrates exemplary menu selections of the preferred embodiment including 1. SELECT PROFILE, 2. UPDATE PROFILES, 3. DISPLAY EVENTS, 4. SET ALERT DURATION, 5. SET MAX ALERT VOLUME, 6. SET REMOTE TIME FROM TV, 7. SET TV TIME FROM REMOTE and 8. DONE. The user selects by menu choice by pressing the menu key to highlight a choice and then pressing the select key. Checking for a select profile user entry is performed as indicated at a decision block 402. If found, the stored profiles are displayed as indicated at a block 404. A user selection is input and the current profile is set as indicated at blocks 406 and 408. Otherwise, checking for an update profile user selection is performed as indicated at a decision block 410. If the update profile user selection is identified, then the profiles are displayed as indicated at a block 412 and a modify profiles routine is performed as indicated at a block 414. The modify profiles routine is illustrated and described with respect to FIG. 8.

When the update profile user selection is not identified, then checking for a display events user selection is performed as indicated at a decision block 416. If the display events user selection is found, then the stored events are displayed as indicated at a block 418. Otherwise, checking for a set alert duration user selection is performed as indicated at a decision block 420. If found, then the alert duration is input as indicated at a block 422. Checking for a max volume user selection is performed as indicated at a decision block 424. If found, then the max volume is input as indicated at a block 426. Checking for a set remote time from TV user selection is performed as indicated at a decision block 428. If found, then the TV time is sent to the remote 104 as indicated at a block 430 and the remote sets its time. Checking for a set TV time from remote user selection is performed as indicated at a decision block 432. If found, then the current time is requested from the remote 104 as indicated at a block 434. Then the remote time is received as indicated at a block 436 and the TV time is set as indicated at a block 438. Otherwise, other standard menu choices are processed as indicated at a block 440. The sequential operations as indicated at block 442 return to calling block 238.

FIG. 5 illustrates exemplary sequential steps for incrementing and decrementing channel control of the preferred embodiment starting at block 500. A current profile is obtained as indicated at a block 502. The current channel list is set to default as indicated at a block 504. For each channel list as indicated at a block 506, checking current day, time within day and time are checked as indicated at a decision block 508. If the current time matches the time of the channel list, then the channel list is set as the current channel list as indicated at a block 510. Then the current channel is found in the current channel list as indicated at a block 512. Then the next or previous channel is found in the current channel list to result in an increment or decrement to the channel selection respectively as indicated at a block 514. Searching for next or previous channel wraps to beginning or end of the channel list as required. The current channel is set to the next or previous channel found in the current channel list as indicated at a block 516. Then the sequential operations return.

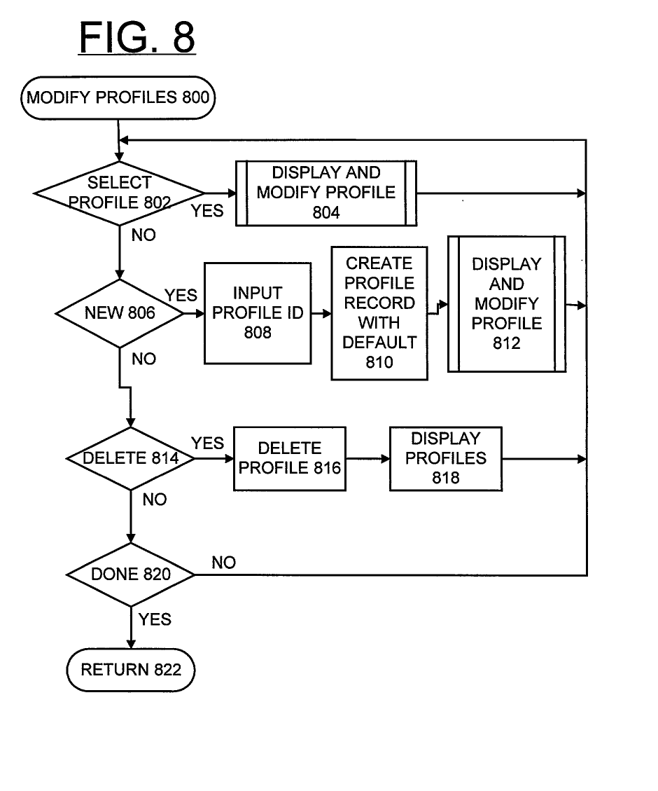

FIG. 8 illustrates exemplary sequential steps for modifying user profiles of the preferred embodiment starting at block 800. The user indicates selection by pressing menu keys to highlight choices and the select key to indicate selection. When a profile user selection is identified as indicated at a decision block 802, then a display and modify profile routine is performed as indicated at a block 804. The display and modify profile routine is illustrated and described with respect to FIG. 9. Then the sequential operations return to block 802 to continue checking for user selections. Checking for a new profile user selection is performed as indicated at a decision block 806. If found, then the profile ID or name, such as 0001 or 0002 in FIG. 7A, is input as indicated at a block 808. A profile record with default values is created as indicated at a block 810. Then the display and modify profile routine is performed as indicated at a block 812 and the operations return to block 802. When a new profile user selection is not found, checking for a delete user selection is performed as indicated at a decision block 814. If the delete user selection is found from the user pressing the delete key, then the current profile is deleted as indicated at a block 816. The profiles are displayed as indicated at a block 818 and the operations return to block 802. Otherwise checking for a done user selection is performed as indicated at a decision block 820. If the delete user selection is found, then the operations return as indicated at a block 822. Otherwise, the operations continue returning to block 802.

FIG. 9 illustrates exemplary sequential steps for displaying and modifying a user profile as shown in FIG. 11 of the preferred embodiment starting at a block 900. First the profile is displayed as indicated at a block 902. The user presses “menu” on remote control 104 to highlight choices, then presses “select” on the remote control to select a channel list or other choice, PREV, NEXT, NEW or DONE. Then checking for a selected channel list user selection is performed as indicated at a decision block 904. If the user selected a channel list the time range is allowed to be modified, except in the case of the default channel list, which time never changes as indicated at a block 906. Then the channels are allowed to be modified as indicated at a block 908. Then the modified profile is displayed at block 902. Otherwise, when select channel list user selection is not identified, then checking for a new channel list user selection is performed as indicated at a decision block 910. If the new channel list is selected, then a new channel list record is stored as indicated at a block 912. The time range is modified according to user input as indicated at a block 914 and the channels are modified according to user input as indicated at a block 916. Then the modified profile is displayed at block 902. When a delete user selection is identified as indicated at a decision block 918, the channel list record is deleted as indicated at a block 920. Then the profile is displayed at block 902. Otherwise when a done user selection is identified as indicated at a decision block 922, then the operations return as indicated at a block 924. When a done user selection is not identified, then the profile in its current setting is displayed at block 902.

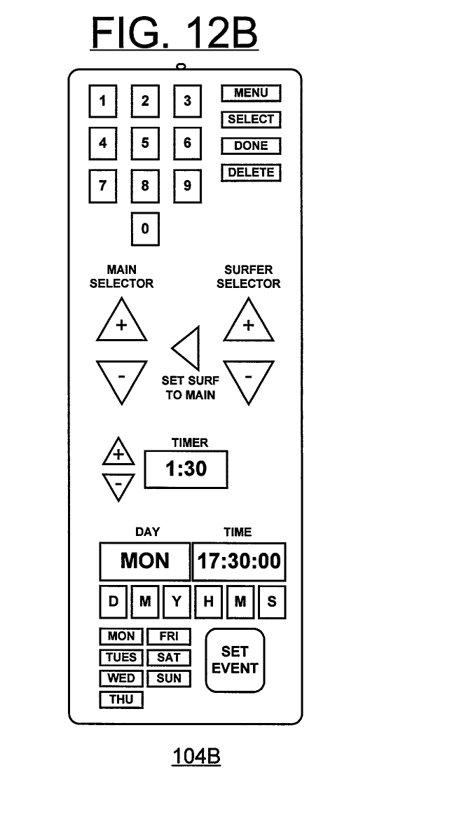

Referring now to FIG. 13, an article of manufacture or a computer program product 1300 of the invention is illustrated. The computer program product 1300 includes a recording medium 1302, such as, a floppy disk, a high capacity read only memory in the form of an optically read compact disk or CD-ROM, a tape, a transmission type media such as a digital or analog communications link, or a similar computer program product. Recording medium 1302 stores program means 1304, 1306, 1308, 1310 on the medium 1302 for carrying out the surfing control methods for television viewing of the preferred embodiment in the television system 100 of FIG. 1.

A sequence of program instructions or a logical assembly of one or more interrelated modules defined by the recorded program means 1304, 1306, 1308, 1310, direct the television system 100 for implementing surfing control methods for television viewing of the preferred embodiment.

While the present invention has been described with reference to the details of the embodiments of the invention shown in the drawing, these details are not intended to limit the scope of the invention as claimed in the appended claims.

What is claimed is:

1. A method for providing surfing control for television viewing comprising the steps of:
receiving user input selections for defining a profile; said profile including at least one channel list;
identifying a user input surfing selection,
identifying a channel list from said profile;
utilizing said identified channel list for selecting a channel responsive to said user input surfing selection.

2. The method for providing surfing control for television viewing as recited in claim 1 further includes the step of setting a surf mode responsive to said user input surfing selection.

3. The method for providing surfing control for television viewing as recited in claim 2 further includes the step of setting a timer event responsive to said user input surfing selection.

4. The method for providing surfing control for television viewing as recited in claim 1 further includes the steps of responding to an event, issuing an audible signal for the viewer, and setting a predefined viewing channel.

5. The method for providing surfing control for television viewing as recited in claim 4 wherein the step of issuing said audible signal for the viewer includes the steps of generating said audible signal with the television and a remote control device.

6. The method for providing surfing control for television viewing as recited in claim 4 further includes the step of powering on the television; and checking for a user acknowledge selection.

7. The method for providing surfing control for television viewing as recited in claim 6 further includes the step of powering off the television responsive to said user acknowledge selection not being received within a predefined time period.

8. The method for providing surfing control for television viewing as recited in claim 7 further includes the step of receiving user input selections for adjusting said predefined time period.

9. The method for providing surfing control for television viewing as recited in claim 1 further includes the step of displaying a menu for receiving user input selections.

10. The method for providing surfing control for television viewing as recited in claim 1 further includes the steps of receiving user input selections for setting an event; and defining an event record.

11. The method for providing surfing control for television viewing as recited in claim 1 further includes the step of providing a remote control device for receiving user input selections.

12. The method for providing surfing control for television viewing as recited in claim 11 further includes the step of providing said remote control device with a plurality of surfing function keys; and wherein said plurality of surfing keys include predefined, separate keys for changing channels for surfing, than used for changing channels for normal viewing.

13. The method for providing surfing control for television viewing as recited in claim 1 further includes the step of defining an event record including an event date and time and a channel.

14. The method for providing surfing control for television viewing as recited in claim 3 further includes the step of receiving user input selections for adjusting a time period for said timer event.

15. The method for providing surfing control for television viewing as recited in claim 1 further includes the step of setting a remote control device time clock from the television by sending a television time to the remote control device.

16. The method for providing surfing control for television viewing as recited in claim 1 further includes the step of setting a television time clock using a remote control device time clock and sending a remote time value to the television.

17. A television surfing control apparatus for controlling for television viewing comprising:
a remote control device receiving user input selections for defining a profile; said profile including at least one channel list;
a television including controller means for identifying a user input surfing selection, means for identifying a channel list from said profile; and
means for utilizing said identified channel list for selecting a channel responsive to said user input surfing selection.

18. The television surfing control apparatus for controlling for television viewing as recited in claim 17 further includes means for identifying an event, means responsive to said identified event for issuing an audible signal for the viewer and for setting a predefined viewing channel.

19. A computer program product for providing surfing control for television viewing comprising:
a recording medium;
means, recorded on the recording medium, for operative controlling a television controller for receiving user input selections and defining a profile; said profile including at least one channel list;
means, recorded on the recording medium, for operative controlling a television controller for identifying a user input surfing selection,
means, recorded on the recording medium, for operative controlling a television controller for identifying a channel list from said profile;
means, recorded on the recording medium, for operative controlling a television controller for utilizing said identified channel list for selecting a channel responsive to said user input surfing selection.

20. The computer program product for providing surfing control for television viewing as recited in claim 19 further includes means, recorded on the recording medium, for identifying an event, for issuing an audible signal for the viewer, and for setting a predefined viewing channel.
